(19) United States
(12) Patent Application Publication
(10) Pub. No.: US 2025/0154965 A1
(43) Pub. Date: May 15, 2025

(54) FAN MOTOR, FAN COMPRISING THE SAME, AND CONTROL METHOD OF FAN MOTOR

(71) Applicant: Zhongshan Broad-Ocean Motor Co., Ltd., Zhongshan (CN)

(72) Inventors: Hairong SUN, Zhongshan (CN); Jie ZHANG, Zhongshan (CN); Xiaosan XU, Zhongshan (CN); Yunsheng CHEN, Zhongshan (CN); Jialin WANG, Zhongshan (CN)

(21) Appl. No.: 19/023,166

(22) Filed: Jan. 15, 2025

Related U.S. Application Data
(63) Continuation-in-part of application No. PCT/CN2023/113411, filed on Aug. 16, 2023.

(30) Foreign Application Priority Data
Jun. 7, 2023 (CN) 202310668901.7

(51) Int. Cl. F04D 29/66; F04D 27/00; H02K 11/33; H02K 21/22; H02P 23/14

(52) U.S. Cl. CPC F04D 29/661; F04D 27/004; H02K 11/33; H02K 21/22; H02P 23/14; H02K 2211/03

(57) ABSTRACT

A fan motor, including: a motor body; and a motor controller. The motor body includes a base, a stator assembly, a rotor assembly, and a flange. The stator assembly is disposed on a sleeve protruding from the base. The rotor assembly is disposed around the stator assembly. The flange is disposed around the rotor assembly and serves as a mounting point for a fan wheel. The motor controller includes a control box and a control circuit board. The control circuit board includes a main control microprocessor, an inverter circuit, and an interface microprocessor. The main control microprocessor is configured to issue signals to operate the inverter circuit. The inverter circuit includes an output interface. The stator assembly includes coil windings. The output interface of the inverter circuit is electrically connected to the coil windings. The interface microprocessor communicates with both the main control microprocessor and a host computer.

### CROSS-REFERENCE TO RELATED APPLICATIONS

This application is a continuation-in-part of International Patent Application No. PCT/CN2023/113411 with an international filing date of Aug. 16, 2023, designating the United States, now pending, further claims foreign priority benefits to Chinese Patent Application No. 202310668901.7 filed Jun. 7, 2023. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a fan motor, a fan comprising the same, and a control method of the fan motor.

Typically, fans include a motor and a fan wheel. During operation, structural factors of the fan can lead to vibrations, which are caused by resonance between the motor, the fan wheel, and mounting brackets at certain frequencies. The resonance generates noise, negatively impacting the user experience and shortens the lifespan of the fan. Traditionally, fan designers do not account for vibration detection mechanisms because the vibrations often relates to the environment where the fan is used. Currently, without vibration detection devices, the fan motor has no means to capture vibration data in real time during operation. As a result, operators cannot adjust the fan speed promptly to prevent excessive vibrations or resonance, which degrades the user experience and reduces product durability. Furthermore, when a vibration detection device is added into an existing motor design, a main control microprocessor is tasked with both collecting and transmitting vibration data, in addition to managing the fan operating data and receiving speed commands from a host computer. The dual processing demand creates data transmission issues, hindering efficient operation of the fan motor.

### SUMMARY

To solve the aforesaid problems, the first objective of the disclosure is to provide a fan motor.

The fan motor comprises a motor body and a motor controller. The motor body comprises a base, a stator assembly, a rotor assembly, and a flange. The stator assembly is disposed on a sleeve protruding from the base. The rotor assembly is disposed around the stator assembly. The flange is disposed around the rotor assembly and serves as a mounting point for a fan wheel. The motor controller comprises a control box and a control circuit board. The control circuit board comprises a main control microprocessor, an inverter circuit, and an interface microprocessor. The main control microprocessor is configured to issue signals to operate the inverter circuit. The inverter circuit comprises an output interface. The stator assembly comprises coil windings. The output interface of the inverter circuit is electrically connected to the coil windings. The interface microprocessor communicates with both the main control microprocessor and a host computer. The control circuit board further comprises a vibration sensor in communication with the interface microprocessor. The host computer sends a speed command to the main control microprocessor via the interface microprocessor. Based on the speed command, the main control microprocessor adjusts the inverter circuit to regulate the motor's speed at a preset speed V. The vibration sensor continuously detects the vibration data of the fan motor operating at the preset speed V and relays the vibration data to the interface microprocessor. The interface microprocessor transmits the vibration data back to the host computer. The main control microprocessor manages the operation of the fan motor and does not process or monitor the vibration data.

In a class of this embodiment, the vibration sensor is a Microelectromechanical Systems sensor (MEMS sensor).

In a class of this embodiment, the rotor assembly is an external rotor assembly.

In a class of this embodiment, the interface microprocessor communicates with the MEMS sensor via a serial communication protocol, either Inter-Integrated Circuit (PC) or Serial Peripheral Interface (SPI).

In a class of this embodiment, the interface microprocessor communicates with the host computer using a Modbus serial communication protocol.

In a class of this embodiment, the interface microprocessor communicates with the main control microprocessor via a Universal Asynchronous Receiver-Transmitter (UART).

The second objective of the disclosure is to provide a method for controlling the fan motor, and the method comprises:
1) powering on the fan motor;
2) sending, using the host computer, the speed command to the interface microprocessor;
3) transmitting, using the interface microprocessor, the speed command to the main control microprocessor; adjusting, using the main control microprocessor, the inverter circuit to regulate the motor's speed at a preset speed V; receiving, using the interface microprocessor, the vibration data detected by the vibration sensor; processing, using the interface microprocessor, the vibration data; sending, using the interface microprocessor, the processed vibration data to the host computer; accessing, by the user, the processed vibration data from the host computer;
4) determining, according to the processed vibration data, whether to adjust the speed command; and
5) repeating 3) and 4) if a new speed command is issued by the user; or continuously operating the fan motor at the current speed if no new speed command is received.

In a class of this embodiment, in 4), the vibration data refers to an amplitude or a frequency of the vibrations detected by the MEMS sensor. The interface microprocessor comprises a read-only memory (ROM) programmed with two thresholds: an amplitude threshold (H0) and a frequency threshold (F0). If the amplitude of the vibrations exceeds the amplitude threshold H0, or if the frequency of the vibrations exceeds the frequency threshold F0, the host computer sends a new speed command to the fan motor. The new speed command gradually decreases or increases the preset speed V until the vibration sensor detects that the amplitude has fallen below H0 or the frequency has dropped below F0.

The third objective of the disclosure is to provide a fan comprising the fan motor and a fan wheel. The fan motor is configured to operate and drive the fan wheel to rotate according to the control method.

The following advantages are associated with the disclosure. The disclosure incorporates the vibration sensor into the fan, thereby enabling real-time monitoring of vibration data during operation. The fan allows for prompt adjustments to the operating speed, preventing excessive vibrations and resonance, thereby enhancing user experience and extending the lifespan of the fan.

### BRIEF DESCRIPTION OF THE DRAWINGS

FIG. 1 is a perspective view of a fan motor according to Example 1 of the disclosure;

FIG. 2 is an exploded view of a fan motor according to Example 1 of the disclosure;

FIG. 3 is a sectional view of a fan motor according to Example 1 of the disclosure;

FIG. 4 is an electronic block diagram of a circuit of a fan motor according to Example 1 of the disclosure;

FIG. 5 is a flowchart of signal transmission in a fan motor according to Example 1 of the disclosure;

FIG. 6 is an enlarged view of FIG. 4; and

FIG. 7 is a flowchart of a control method of a fan motor according to Example 2 of the disclosure.

### DETAILED DESCRIPTION

To further illustrate the disclosure, embodiments detailing a fan motor, a fan comprising the same, and the control method of the fan motor are described below. It should be noted that the following embodiments are intended to describe and not to limit the disclosure.

### Example 1

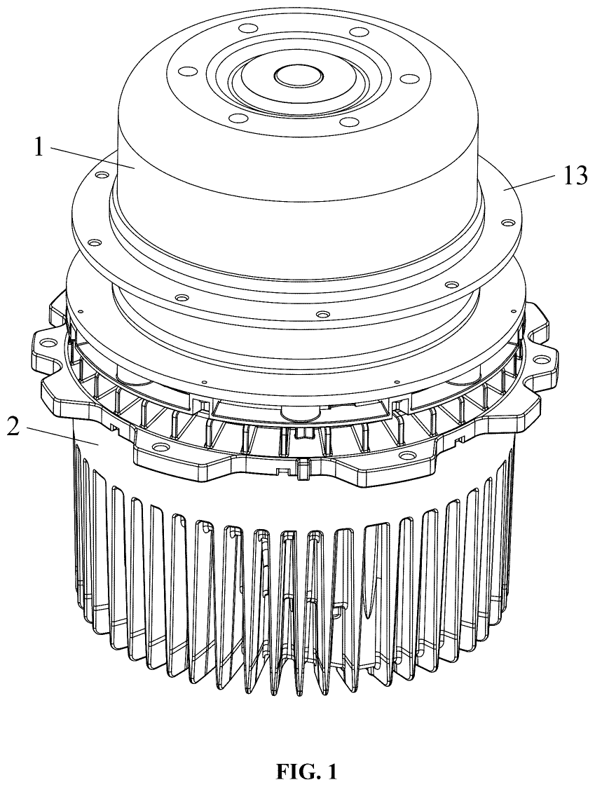

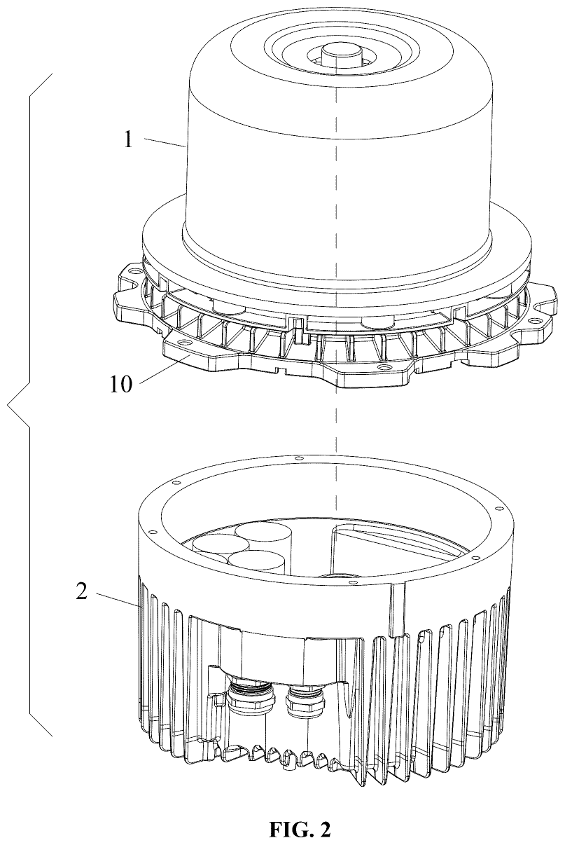

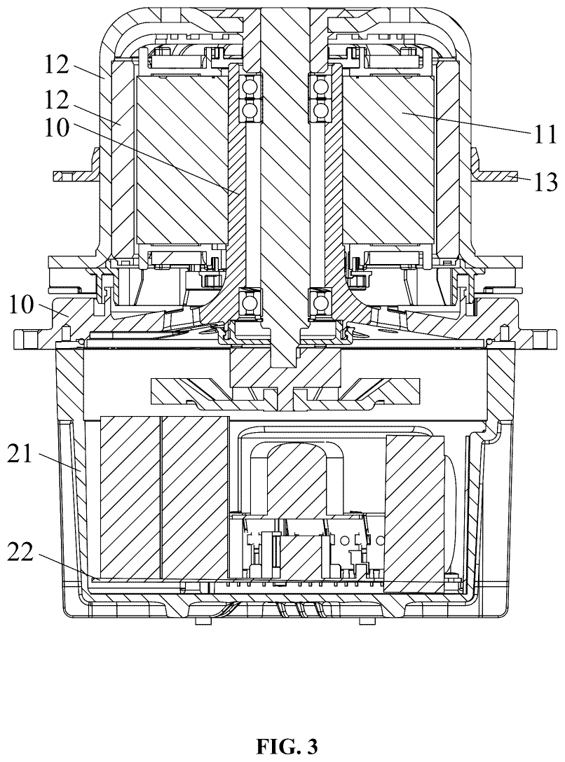

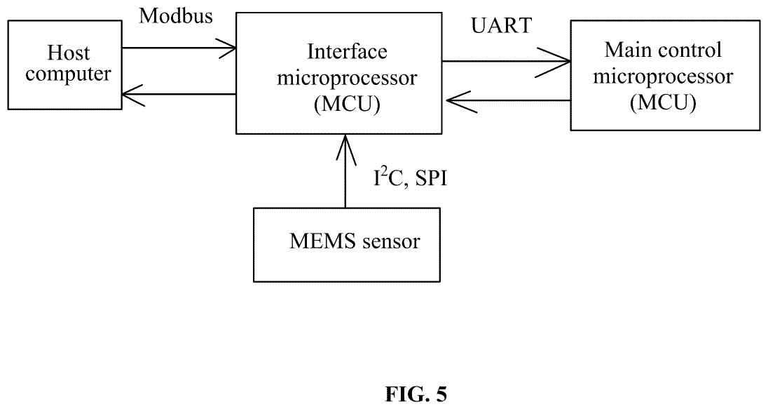

As shown in FIGS. 1-5, a fan motor comprises a motor body 1 and a motor controller 2. The motor body 1 comprises a base 10, a stator assembly 11, a rotor assembly 12, and a flange 13. The stator assembly 11 is disposed on a sleeve protruding from the base 10. The rotor assembly 12 is disposed around the stator assembly 11. The flange 13 is disposed around the rotor assembly 12 and serves as a mounting point for a fan wheel. The motor controller 2 comprises a control box 21 and a control circuit board 22. The control circuit board 22 comprises a main control microprocessor, an inverter circuit, and an interface microprocessor. The main control microprocessor is configured to issue signals to operate the inverter circuit. The inverter circuit comprises an output interface. The stator assembly comprises coil windings. The output interface of the inverter circuit is electrically connected to the coil windings. The interface microprocessor communicates with both the main control microprocessor and a host computer. The control circuit board further comprises a vibration sensor in communication with the interface microprocessor. The host computer sends a speed command to the main control microprocessor via the interface microprocessor. Based on the speed command, the main control microprocessor adjusts the motor's speed to a preset speed V via the inverter circuit. The vibration sensor continuously detects the vibration data of the fan motor operating at the preset speed V and relays the vibration data to the interface microprocessor. The interface microprocessor transmits the vibration data back to the host computer. The main control microprocessor manages the operation of the fan motor and does not process or monitor the vibration data. The rotor assembly is an external rotor assembly.

The vibration sensor is a Microelectromechanical Systems (MEMS) sensor. MEMS technology, originating from microelectronics advancements, integrates microelectronic and micromechanical fabrication, allowing for the production of sensors that are smaller and lighter than conventional sensors. The MEMS sensors provide several benefits, such as compact size, low weight, affordability, and low power consumption, and high reliability. They are also well-suited for mass production, ease to integrate, and ideal for smart system applications.

The interface microprocessor communicates with the MEMS sensor via a serial communication protocol, either Inter-Integrated Circuit (FC) or Serial Peripheral Interface (SPI). FC is a simple, bidirectional, two-wire synchronous serial bus developed by Philips, requiring just two wires to transmit data, making it convenient for connecting multiple devices on a shared bus.

SPI is a high-speed, full-duplex, synchronous communication bus.

The interface microprocessor communicates with the host computer using a Modbus serial communication protocol. Developed by Modicon (now Schneider Electric) in 1979 specific for programmable logic controllers (PLCs), Modbus has since become a widely adopted protocol across industry environments. The Modbus serial communication protocol provides a reliable and standardized way to connect and control industrial electronic devices, ensuring consistent data exchange in real-time exchange.

The interface microprocessor communicates with the main control microprocessor via a Universal Asynchronous Receiver-Transmitter (UART). The UART is a hardware component that converts data between serial format and parallel format.

The following advantages are associated with the disclosure.

1. The interface microprocessor is configured to continuously monitor the vibration data and send the vibration data to the host computer. The interface microprocessor frees up the main control microprocessor to focus exclusively on motor operation, thereby reducing the processing load of the main control microprocessor, and enhancing the motor control performance.

2. The MEMS sensor communicates with the interface microprocessor to detect the vibration data in real time. The vibration data is stored temporarily in the RAM of the interface microprocessor. The RAM storage allows the host computer quick access to the up-to-date vibration data. Since the RAM storage clears when powered off, the clearing helps avoid data overload on the interface microprocessor, maintaining efficient operation.

3. During operation, the host computer uses the vibration data to assess motor performance and adjusts the speed command as needed. The feedback mechanisms allow the operator to modify motor speed to minimize excessive vibrations or resonance, improving motor reliability and user experience.

The fan motor focuses on NVH (Noise, Vibration, and Harshness) analysis that is a key metric in assessing quality in automotive and other manufacturing fields. NVH analysis evaluates noise, vibration, and harshness to ensure optimal performance and durability.

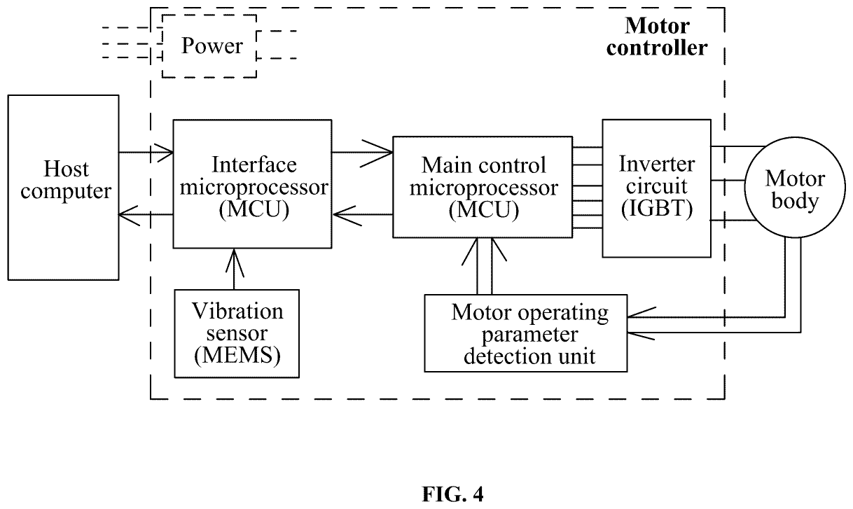

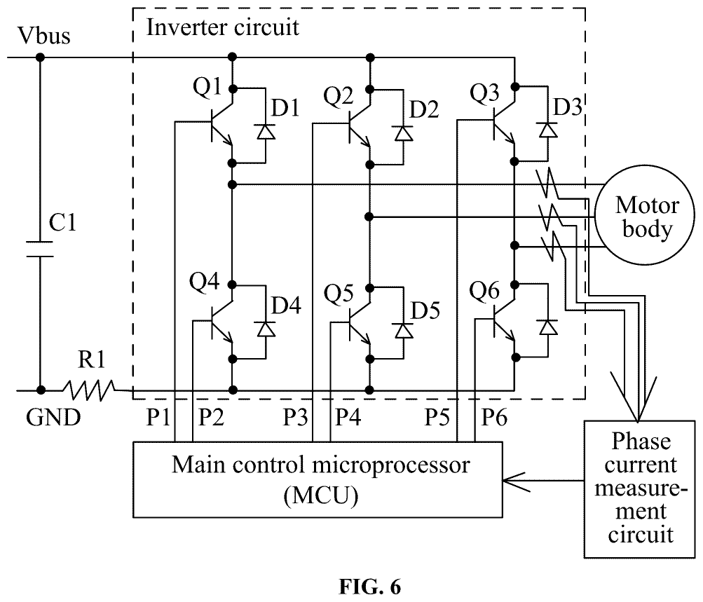

As shown in FIG. 6, the inverter circuit comprises six Insulated-Gate Bipolar Transistor (IGBT) switches (Q1, Q2, Q3, Q4, Q5, and Q6). The motor body 1 is a three-phase motor. As shown in FIG. 4, the operation parameters of the fan motor are detected by a phase current measurement circuit or a Hall sensor. The Hall sensor is configured to detect the rotor position. The main control microprocessor outputs six signals (P1, P2, P3, P4, P5, and P6) to manage the six IGBT switches (Q1, Q2, Q3, Q4, Q5, and Q6), respectively.

The vibration sensor monitors the vibration data in real time, enabling immediate speed adjustments. The adaptive control minimizes excessive vibration or resonance, enhancing both the user experience and lifespan of the fan motor.

### Example 2

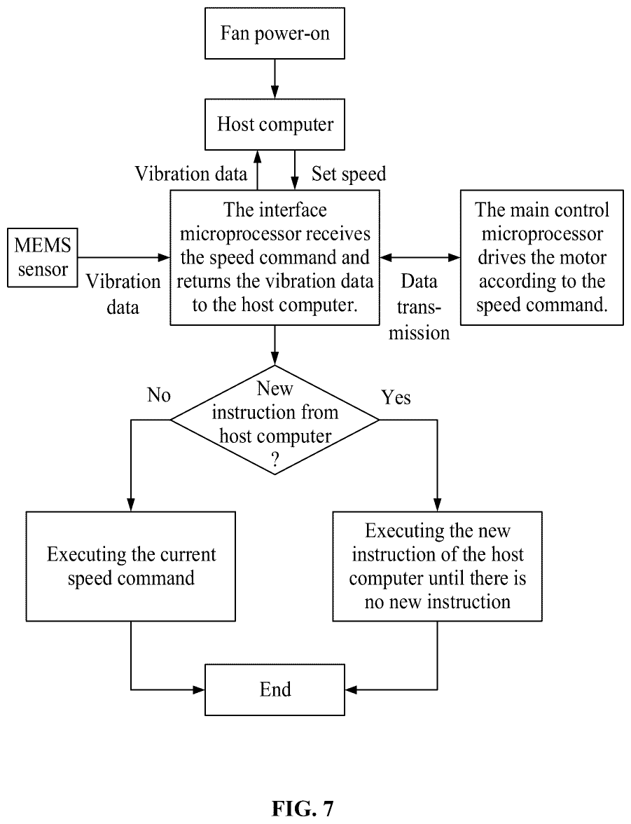

As shown in FIG. 7, a method for controlling the fan motor described in Example 1, comprising:
1) powering on the fan motor;
2) sending, using the host computer, the speed command to the interface microprocessor;
3) transmitting, using the interface microprocessor, the speed command to the main control microprocessor; adjusting, using the main control microprocessor, the inverter circuit to regulate the motor's speed at a preset speed V; receiving, using the interface microprocessor, the vibration data detected by the vibration sensor; processing, using the interface microprocessor, the vibration data; sending, using the interface microprocessor, the processed vibration data to the host computer; accessing, by the user, the processed vibration data from the host computer;
4) determining, according to the processed vibration data, whether to adjust the speed command; and
5) repeating 3) and 4) if a new speed command is issued by the user; or continuously operating the fan motor at the current speed if no new speed command is received.

In 4), the vibration data refers to an amplitude or a frequency of the vibrations detected by the MEMS sensor. The interface microprocessor comprises a read-only memory (ROM) programmed with two thresholds: an amplitude threshold (H0) and a vibration frequency threshold (F0). If the amplitude of the vibrations exceeds the amplitude threshold H0, or if the frequency of the vibrations exceeds the vibration frequency threshold F0, the host computer sends the new speed command to the fan motor. The new speed command gradually decreases or increases the preset speed V until the vibration sensor detects that the amplitude has fallen below H0 or the frequency has dropped below F0.

The disclosure incorporates the vibration sensor into the fan, thereby enabling real-time monitoring of vibration data during operation. The fan allows for prompt adjustments to the operating speed, preventing excessive vibrations and resonance, thereby enhancing user experience and extending the lifespan of the fan.

### Example 3

The disclosure further provides a fan comprising the abovementioned fan motor and a fan wheel. The fan motor is configured to operate and drive the fan wheel to rotate according to the control method described in Example 2.

It will be obvious to those skilled in the art that changes and modifications may be made, and therefore, the aim in the appended claims is to cover all such changes and modifications.

What is claimed is:

1. A fan motor, comprising:
a motor body; and
a motor controller;
wherein:
the motor body comprises a base, a stator assembly, a rotor assembly, and a flange; the stator assembly is disposed on a sleeve protruding from the base; the rotor assembly is disposed around the stator assembly; the flange is disposed around the rotor assembly and serves as a mounting point for a fan wheel;
the motor controller comprises a control box and a control circuit board; the control circuit board comprises a main control microprocessor, an inverter circuit, and an interface microprocessor; the main control microprocessor is configured to issue signals to operate the inverter circuit; the inverter circuit comprises an output interface; the stator assembly comprises coil windings; the output interface of the inverter circuit is electrically connected to the coil windings; the interface microprocessor communicates with both the main control microprocessor and a host computer; the control circuit board further comprises a vibration sensor communicating with the interface microprocessor; and
when in use, the host computer sends a speed command to the main control microprocessor via the interface microprocessor; based on the speed command, the main control microprocessor adjusts the inverter circuit to regulate the motor's speed at a preset speed V; the vibration sensor continuously detects the vibration data of the fan motor operating at the preset speed V and relays the vibration data to the interface microprocessor; and the interface microprocessor transmits the vibration data back to the host computer.

2. The fan motor of claim 1, wherein the vibration sensor is a microelectromechanical systems (MEMS) sensor.

3. The fan motor of claim 2, wherein the MEMS sensor is a microelectromechanical system integrating microelectronic and micromechanical fabrication.

4. The fan motor of claim 2, wherein the interface microprocessor communicates with the MEMS sensor via a serial communication protocol of inter-integrated circuit (PC) or serial peripheral interface (SPI).

5. The fan motor of claim 4, wherein the interface microprocessor communicates with the host computer using a Modbus serial communication protocol.

6. The fan motor of claim 5, wherein the interface microprocessor communicates with the main control microprocessor via a Universal Asynchronous Receiver-Transmitter (UART).

7. The fan motor of claim 6, wherein the rotor assembly is an external rotor assembly.

8. A method for controlling the fan motor of claim 1, the method comprising:
1) powering on the fan motor;
2) sending, by a user using the host computer, the speed command to the interface microprocessor;
3) transmitting, using the interface microprocessor, the speed command to the main control microprocessor; adjusting, using the main control microprocessor, the inverter circuit to regulate the motor's speed at a preset speed V; receiving, using the interface microprocessor, the vibration data detected by the vibration sensor; processing, using the interface microprocessor, the vibration data; sending, using the interface microprocessor, processed vibration data to the host computer; accessing, by the user, the processed vibration data from the host computer;
4) determining, according to the processed vibration data, whether to adjust the speed command; and
5) repeating 3) and 4) if a new speed command is issued by the user, or continuously operating the fan motor at a current speed if no new speed command is received.

9. The method of claim 8, wherein in 4), the vibration data refers to an amplitude or a frequency of vibrations detected by the MEMS sensor; the interface microprocessor comprises a read-only memory (ROM) programmed with two thresholds: an amplitude threshold (H0) and a vibration frequency threshold (F0); if the amplitude of the vibrations exceeds the amplitude threshold H0, or if the frequency of the vibrations exceeds the vibration frequency threshold F0, the host computer sends the new speed command to the fan motor; the new speed command gradually decreases or increases the preset speed V until the vibration sensor detects that the amplitude has fallen below H0 or the frequency has dropped below F0.

10. A fan, comprising:
the fan motor; and
a fan wheel;
wherein:
the fan motor is configured to operate and drive the fan wheel to rotate according to the method of claim 9.
